(19) United States
(12) Patent Application Publication
(10) Pub. No.: US 2026/0131395 A1
(43) Pub. Date: May 14, 2026

(54) WIRE BONDING TOOLS, AND RELATED METHODS OF PROVIDING THE SAME

(71) Applicant: Kulicke and Soffa Industries, Inc., Fort Washington, PA (US)

(72) Inventors: Cristian D. Cionea, Fort Washington, PA (US); Christoph B. Luechinger, Fort Washington, PA (US); Raymond Chen, Fort Washington, PA (US)

(73) Assignee: Kulicke and Soffa Industries, Inc., Fort Washington, PA (US)

(21) Appl. No.: 19/444,680

(22) Filed: Jan. 9, 2026

Related U.S. Application Data
(62) Division of application No. 18/133,447, filed on Apr. 11, 2023.
(60) Provisional application No. 63/336,033, filed on Apr. 28, 2022.

(51) Int. Cl. B23K 20/02; B23K 20/00; B23K 101/32

(52) U.S. Cl. CPC B23K 20/025; B23K 20/007; B23K 2101/32

(57) ABSTRACT

A wire bonding tool is provided. The wire bonding tool includes a body portion including a tip portion. The wire bonding tool also includes a first coating applied to the tip portion. The wire bonding tool also includes a second coating applied to the first coating.

### CROSS REFERENCE TO RELATED APPLICATION

This application is a divisional application of U.S. patent application Ser. No. 18/133,447, filed Apr. 11, 2023, which claims the benefit of U.S. Provisional Application No. 63/336,033, filed on Apr. 28, 2022, the contents of both of which are incorporated herein by reference.

### FIELD

The invention relates to wire bonding tools, and in particular, wire bonding tools including coatings, and to methods of providing the same.

### BACKGROUND

In the processing and packaging of semiconductor devices and other electronics assemblies, wire bonding continues to be the primary method of providing electrical interconnection between two locations within a package (e.g., between a die pad of a semiconductor die and a lead of a leadframe). More specifically, using a wire bonder (also known as a wire bonding machine) wire loops are formed between respective locations to be electrically interconnected. The primary methods of forming wire loops are ball bonding and wedge bonding (including ribbon bonding).

In the wire bonding industry, contamination (including adhesion of wire) at a tip of the wire bonding tool, and surface wear of the tip of the wire bonding tool, limit the useable life of the wire bonding tool.

U.S. Pat. No. 6,729,527 (entitled “BONDING TOOL WITH POLYMER COATING”) and U.S. Pat. No. 6,171,456 (entitled “METHOD FOR MAKING IMPROVED LONG LIFE BONDING TOOLS”) relate to coating of wire bonding tools and are incorporated herein by reference in their entirety.

It would be desirable to provide improved wire bonding tools which overcome one or more of the deficiencies of conventional wire bonding tools.

### SUMMARY

According to an exemplary embodiment of the invention, a wire bonding tool is provided. The wire bonding tool includes a body portion including a tip portion. The wire bonding tool also includes a first coating applied to the tip portion. The wire bonding tool also includes a second coating applied to the first coating.

According to exemplary aspects of the invention, the wire bonding tool referred to in the preceding paragraph may include any one or more of the following features: the body portion includes at least one of a ceramic, a metal alloy, a metal matrix composite, and a ceramic matrix composite; the first coating is resistant to at least one of corrosion and wear; the first coating includes at least one of a metal, a metallic compound, and a ceramic; the first coating includes at least one of chromium, titanium, chromium carbide, chromium nitride and titanium nitride; the first coating has a thickness of 0.5 to 10 microns; the first coating has a thickness of 0.5 to 2 microns; the second coating is resistant to at least one of stiction and friction; the second coating is carbon-based; the second coating includes at least one of a diamond-like carbon, a non-hydrogenated diamond-like carbon, a tetragonal amorphous carbon, and a carbon-based coating; the second coating has a thickness of 0.1 to 10 microns; and the second coating has a thickness of 0.3 to 5 microns.

According to another exemplary embodiment of the invention, a method of providing a wire bonding tool is provided. The method includes the steps of: (a) providing a body portion of a wire bonding tool, the body portion including a tip portion; (b) applying a first coating to the tip portion; and (c) applying a second coating to the first coating.

According to exemplary aspects of the invention, the method referred to in the preceding paragraph may include any one or more of the following features: the body portion provided in step (a) includes at least one of a ceramic, a metal alloy, a metal matrix composite, and a ceramic matrix composite; the first coating provided in step (b) is resistant to at least one of corrosion and wear; the first coating provided in step (b) includes at least one of a metal, a metallic compound, and a ceramic; the first coating provided in step (b) includes at least one of chromium, titanium, chromium carbide, chromium nitride and titanium nitride; the first coating provided in step (b) has a thickness of 0.5 to 10 microns; the first coating provided in step (b) has a thickness of 0.5 to 2 microns; the second coating provided in step (c) is resistant to at least one of stiction and friction; the second coating provided in step (c) is carbon-based; the second coating provided in step (c) includes at least one of a diamond-like carbon, a non-hydrogenated diamond-like carbon, a tetragonal amorphous carbon, and a carbon-based coating; the second coating provided in step (c) has a thickness of 0.1 to 10 microns; the second coating provided in step (c) has a thickness of 0.3 to 5 microns; the method further comprises the steps of cleaning a surface of tip portion prior to step (b) and activating the surface of the tip portion after the step of cleaning but before step (b); the step of cleaning includes degreasing the surface of the tip portion; the step of cleaning includes plasma cleaning the surface of the tip portion; the method further comprises the step of activating the surface of the tip portion after step (b) but before step (c); step (b) includes applying the first coating using at least one of cathodic arc, filtered cathodic vacuum arc, and chemical vapor deposition; and step (c) includes applying the second coating using at least one of cathodic arc, filtered cathodic vacuum arc, and chemical vapor deposition.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIGS. 1A-1C are partial cross-sectional side views of various exemplary bonding tools useful in explaining the invention;

FIGS. 2A-2C are partial cross-sectional side views of the wire bonding tools of FIGS. 1A-1C, in the process of being coated in accordance with various exemplary embodiments of the invention;

FIGS. 3A-3C are partial cross-sectional side views of the wire bonding tools of FIGS. 1A-1C, having been coated in accordance with various exemplary embodiments of the wire invention;

FIG. 4 is a detail view of a portion of the wire bonding tools illustrated in FIGS. 3A-3C in accordance with various exemplary embodiments of the invention; and

FIG. 5 is a flow diagram illustrating a method of providing a wire bonding tool in accordance with various exemplary embodiments of the invention.

### DETAILED DESCRIPTION

As used herein, the term “wire bonding tool” is intended to refer to any of a number of types of wire bonding tools such as wedge bonding tools (e.g., small wire wedges, heavy wire wedges, etc.), ball bonding tools (e.g., a capillary tools), ribbon bonding tools, etc.

As used herein, a “coating” refers to a material applied to a surface of a wire bonding tool. Although a second coating may be “applied” to a first coating, this does not necessarily mean the second coating is directly applied to a first coating. In other words, an intermediate coating or layer may separate the second and first coating; thus, a second coating may be indirectly applied to a first coating. Similarly, a coating (e.g., a first coating, a second coating, etc.) may be indirectly applied to a wire bonding tool. A “first” coating is not necessarily the innermost coating or layer to a wire bonding tool; further, the “second” coating may not necessarily be the outermost coating.

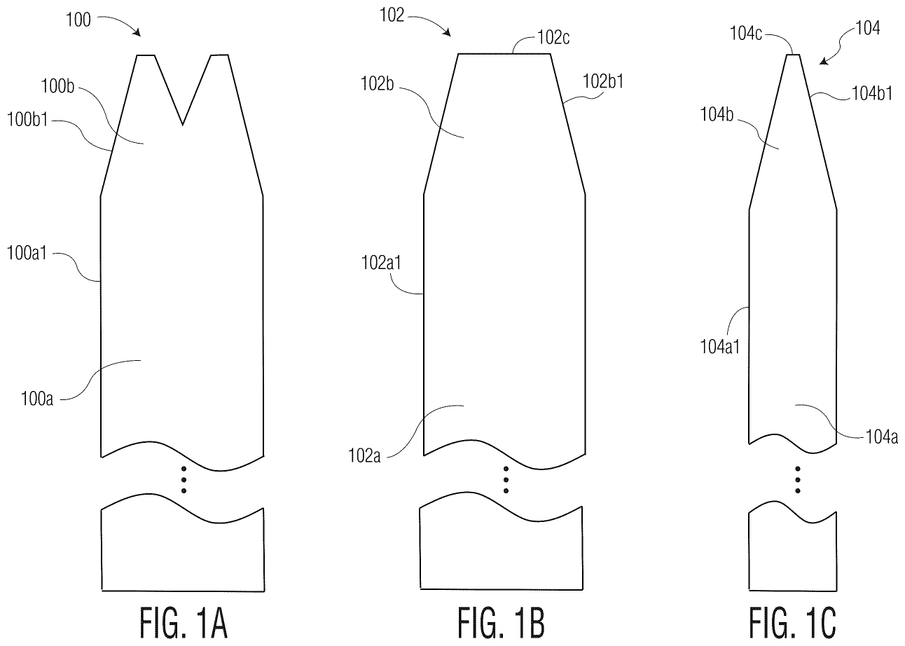

Referring now to the drawings, FIGS. 1A-1C illustrate various wire bonding tools. More specifically, FIG. 1A illustrates a wedge bonding tool including a “V-shaped” groove, FIG. 1B illustrates a ribbon bonding tool, and FIG. 1C illustrates a small wire wedge bonding tool. Of course, additional types of wire bonding tools are contemplated within the scope of the invention. FIGS. 1A-1C illustrate the tip portions of the various wire bonding tools. The tip portions are the part of the wire bonding tools that make contact with a workpiece during a wire bonding operation.

Referring specifically to FIG. 1A, a wire bonding tool 100 is illustrated. Wire bonding tool 100 includes a body portion 100a including a tip portion 100b at a terminal end. Body portion 100a includes a surface 100a1. Tip portion 100b includes part of surface 100a1 labelled as a surface 100b1. Tip portion 100b defines a V-shaped groove configured to receive a wire during a wire bonding operation.

Referring now to FIG. 1B, a wire bonding tool 102 (e.g., a ribbon bonding tool) is illustrated. Wire bonding tool 102 includes a body portion 102a including a tip portion 102b at a terminal end. Body portion 102a includes a surface 102a1. Tip portion 102b includes part of surface 102a1 labelled as a surface 102b1. Tip portion 102b includes a bonding surface 102c configured to contact a wire during a wire bonding operation.

Referring now to FIG. 1C, a wire bonding tool 104 is illustrated. Wire bonding tool 104 includes a body portion 104a including a tip portion 104b at a terminal end. Body portion 104a includes a surface 104a1. Tip portion 104b includes part of surface 104a1 labelled as a surface 104b1. Tip portion 104b includes a bonding surface 104c configured to contact a wire during a wire bonding operation.

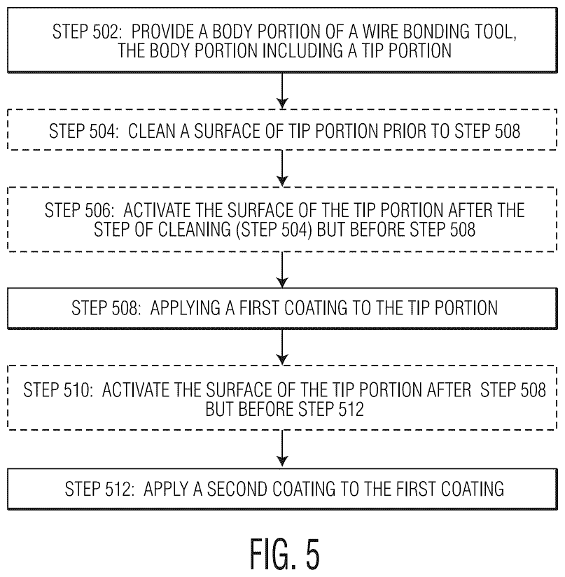

Wire bonding tool 100, wire bonding tool 102, and wire bonding tool 104 may be described as “uncoated”. Prior to an application of coatings to the wire bonding tools, each of wire bonding tools 100, 102 and 104 may be cleaned (e.g., degreased or otherwise cleaned as needed based on the type of tool and the coating to be applied). More specifically, at least the tip portion of each of the wire bonding tools may be cleaned (e.g., surface 100b1, surface 102b1, and bonding surface 102c). Of course, the entire surface of each of the wire bonding tools may also be cleaned. Further, a surface of each of the wire bonding tools (e.g., at least at the respective tip portion) may be “activated” such that the surfaces are more receptive to coating (e.g., see Step 506 of FIG. 5). As will be understood by those skilled in the art, surface activation (e.g., of a metal wedge bonding tool) changes a surface energy of the wire bonding tool so it is more likely to attract coating particles.

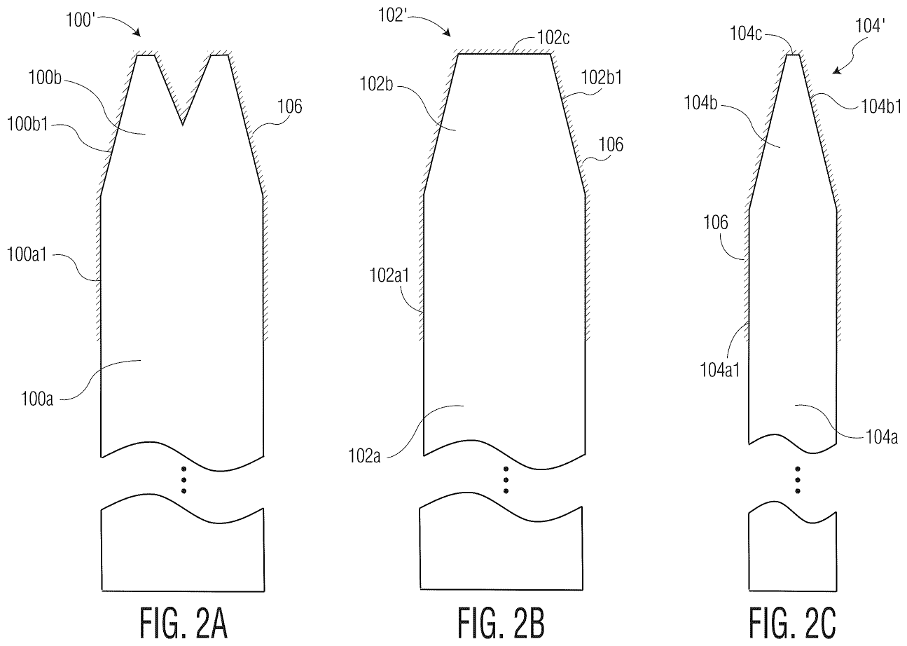

Referring now to FIGS. 2A-2C, each of wire bonding tools 100, 102, and 104 has received a respective first coating, such that the tools are now labelled as wire bonding tools 100′, 102′, and 104′. Wire bonding tool 100′ includes a first coating 106 applied to tip portion 100b, wire bonding tool 102′ includes a first coating 106 applied to tip portion 102b, and wire bonding tool 104′ includes a first coating 106 applied to tip portion 104b. The respective first coatings may be considered an inner coating or layer applied to the respective surface of the tip portion of the wire bonding tool. Although FIGS. 2A-2C illustrate the first coating 106 applied only to the tip portion of the respective wire bonding tool, it is understood that any portion of the surface of the wire bonding tool (including the entire surface) may be coated.

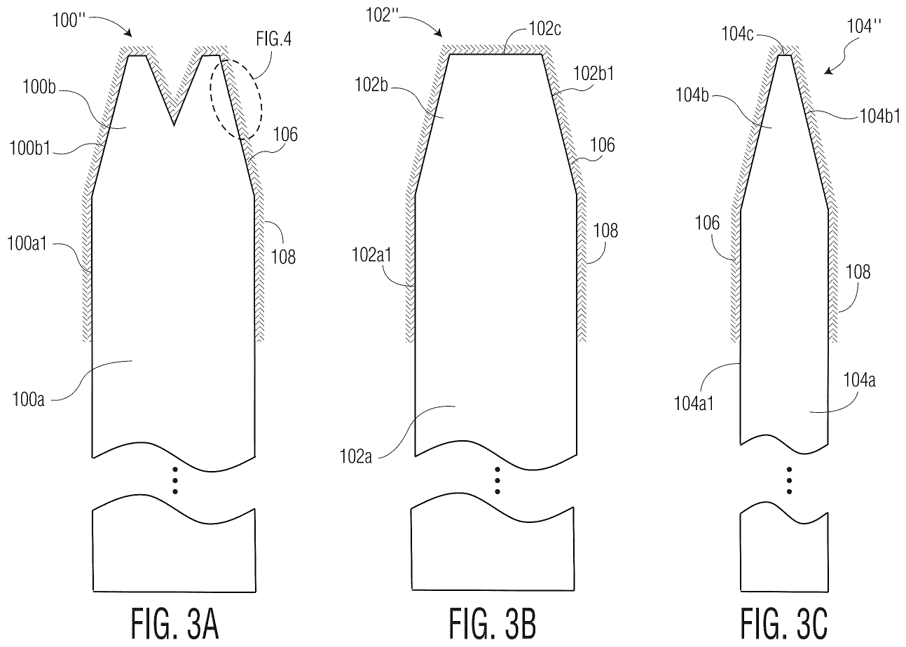

Referring now to FIGS. 3A-3C, each of wire bonding tools 100, 102, and 104 has received a respective second coating (after the first coating 106 shown in FIGS. 2A-2C), such that the tools are now labelled as wire bonding tools 100″, 102″, and 104″. Wire bonding tool 100″ includes a second coating 108 (on first coating 106) applied to tip portion 100b, wire bonding tool 102″ includes a second coating 108 (on first coating 106) applied to tip portion 102b, and wire bonding tool 104″ includes a second coating 108 (on first coating 106) applied to tip portion 104b. The respective second coatings may be considered an outer coating or layer applied to the first (or inner) coating of the tip portion of the respective wire bonding tool. Although FIGS. 3A-3C illustrate the second coating 108 applied only to the tip portion of the respective wire bonding tool, it is understood that any portion of the surface of the wire bonding tool (including the entire surface) may be coated.

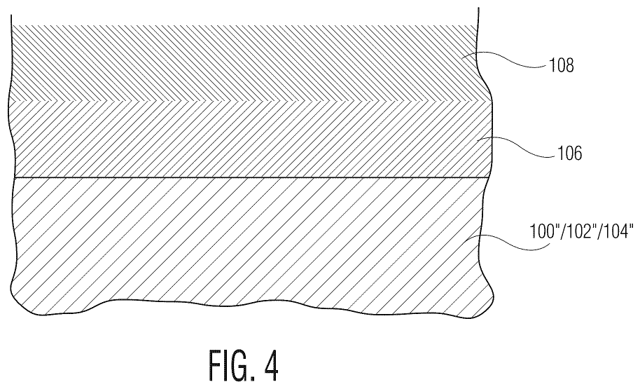

Referring now to FIG. 4, a portion of wire bonding tool 100″ (or wire bonding tool 102″ or wire bonding tool 104″) is illustrated to more clearly show first coating 106 and second coating 108. Although FIG. 4 illustrates first coating 106 and second coating 108 as approximately equal in thickness, the invention is not so limited. For example, in certain embodiments of the invention, first coating 106 may have a thickness of 0.5 to 10 microns; in other embodiments of the invention, first coating 106 may have a thickness of 0.5 to 2 microns. For example, in certain embodiments of the invention, second coating 108 may have a thickness of 0.1 to 10 microns; in other embodiments of the invention, second coating 108 may have a thickness of 0.3 to 5 microns. Of course, these ranges are exemplary in nature. The exact thickness of first coating 106 or second coating 108 will depend on the application and conditions related to a particular bonding operation.

FIG. 5 is a flow diagram of various methods of providing a bonding tool. As is understood by those skilled in the art, certain steps included in the flow diagram may be omitted; certain additional steps may be added; and the order of the steps may be altered from the order illustrated—all within the scope of the invention.

At Step 502, a body portion of a wire bonding tool is provided, the body portion including a tip portion (e.g., see body portions 100a, 102a, and 104a including respective tip portions in FIGS. 1A-1C). For example, the body portion provided in Step 502 may include (or be made entirely from) a ceramic, a metal alloy, a metal matrix composite, or a ceramic matrix composite. At optional Step 504, a surface of the tip portion of the wire bonding tool is cleaned prior to Step 508. The step of cleaning (i.e., Step 504) may include degreasing the surface of the tip portion. The step of cleaning (i.e., Step 504) may include plasma cleaning the surface of the tip portion. At optional Step 506, the surface of the tip portion is activated after the step of cleaning (i.e., Step 504) but before Step 508. This “activation” refers to increasing the surface energy of a material, making the material more receptive to another material (i.e., via forming atomic bonds). This activation may be accomplished by applying energy (e.g., a plasma) to a surface desired to be activated.

At Step 508, a first coating is applied to the tip portion (e.g., see FIGS. 2A-2C). The coating provided at Step 508 may be resistant to corrosion or wear. For example, the coating (i.e., the first coating) provided at Step 508 may include (or be made entirely from) a metal, a metallic compound, and a ceramic. For example, the coating provided at Step 508 may include (or be made entirely from) chromium, titanium, chromium carbide, chromium nitride and titanium nitride. For example, the coating provided at Step 508 may have a thickness of 0.5 to 10 microns; in another example, the coating may have a thickness of 0.5 to 2 microns. The coating provided at Step 508 may be applied, for example, using cathodic arc coating techniques, using filtered cathodic vacuum arc coating techniques, or using chemical vapor deposition. At optional Step 510, the surface of the tip portion is activated after Step 508, but before Step 512.

At Step 512, a second coating is applied to the first coating (e.g., see FIGS. 3A-3C). The coating (i.e., the second coating) provided at Step 512 may be resistant to stiction or friction. The coating provided at Step 512 may be carbon-based. For example, the coating provided at Step 512 may include (or be made entirely from) a diamond-like carbon, a non-hydrogenated diamond-like carbon, a tetragonal amorphous carbon, and a carbon-based coating. For example, the coating provided at Step 512 may have a thickness of 0.1 to 10 microns; in another example, the coating may have a thickness of 0.3 to 5 microns. The coating provided at Step 512 may be applied, for example, using cathodic arc coating techniques, using filtered cathodic vacuum arc coating techniques, or using chemical vapor deposition.

Although the invention is illustrated and described herein with reference to specific embodiments, the invention is not intended to be limited to the details shown. Rather, various modifications may be made in the details within the scope and range of equivalents of the claims and without departing from the invention.

1. A method of providing a wedge bonding tool, the method comprising the steps of:
(a) providing a body portion of the wedge bonding tool, the body portion including a tip portion, the tip portion defining a V-shaped groove configured to receive a wire during a wire bonding operation;
(b) applying a first coating to the tip portion including the V-shaped groove; and
(c) applying a second coating to the first coating.

2. The method of claim 1 wherein the body portion provided in step (a) includes at least one of a ceramic, a metal alloy, a metal matrix composite, and a ceramic matrix composite.

3. The method of claim 1 wherein the first coating provided in step (b) is resistant to at least one of corrosion and wear.

4. The method of claim 1 wherein the first coating provided in step (b) includes at least one of a metal, a metallic compound, and a ceramic.

5. The method of claim 1 wherein the first coating provided in step (b) includes at least one of chromium, titanium, chromium carbide, chromium nitride and titanium nitride.

6. The method of claim 1 wherein the first coating provided in step (b) has a thickness of 0.5 to 10 microns.

7. The method of claim 1 wherein the first coating provided in step (b) has a thickness of 0.5 to 2 microns.

8. The method of claim 1 wherein the second coating provided in step (c) is resistant to at least one of stiction and friction.

9. The method of claim 1 wherein the second coating provided in step (c) is carbon-based.

10. The method of claim 1 wherein the second coating provided in step (c) includes at least one of a diamond-like carbon, a non-hydrogenated diamond-like carbon, a tetragonal amorphous carbon, and a carbon-based coating.

11. The method of claim 1 wherein the second coating provided in step (c) has a thickness of 0.1 to 10 microns.

12. The method of claim 1 wherein the second coating provided in step (c) has a thickness of 0.3 to 5 microns.

13. The method of claim 1 further comprising the steps of cleaning a surface of tip portion prior to step (b) and activating the surface of the tip portion after the step of cleaning but before step (b).

14. The method of claim 13 wherein the step of cleaning includes degreasing the surface of the tip portion.

15. The method of claim 13 wherein the step of cleaning includes plasma cleaning the surface of the tip portion.

16. The method of claim 13 further comprising the step of activating the surface of the tip portion after step (b) but before step (c).

17. The method of claim 1 wherein step (b) includes applying the first coating using at least one of cathodic arc, filtered cathodic vacuum arc, and chemical vapor deposition.

18. The method of claim 1 wherein step (c) includes applying the second coating using at least one of cathodic arc, filtered cathodic vacuum arc, and chemical vapor deposition.

19. A method of providing a wedge bonding tool, the method comprising the steps of:
(a) providing a body portion of the wedge bonding tool, the body portion including a tip portion, the tip portion defining a V-shaped groove configured to receive a wire during a wire bonding operation;
(b) activating a surface of the tip portion before step (c) to change a surface energy of the wedge bonding tool so it is more likely to attract coating particles;
(c) applying a first coating to the tip portion including the V-shaped groove; and
(d) applying a second coating to the first coating.

20. A method of providing a wedge bonding tool, the method comprising the steps of:
(a) providing a body portion of the wedge bonding tool, the body portion including a tip portion, the tip portion defining a V-shaped groove configured to receive a wire during a wire bonding operation;
(b) activating a surface of the tip portion before step (c) to change a surface energy of the wedge bonding tool so it is more likely to attract coating particles;
(c) applying a first coating to the tip portion including the V-shaped groove;
(d) activating a surface of the tip portion after step (c) but before step (e); and
(e) applying a second coating to the first coating.
